(19) United States
(12) Patent Application Publication
(10) Pub. No.: US 2009/0134676 A1
(43) Pub. Date: May 28, 2009

(54) Vehicle seat with a seat heater

(76) Inventors: Joshi Raghvendra Trimbakrao, Windsor (CA); Jochen Michelmann, Gelnhausen (DE)

Correspondence Address: MILDE & HOFFBERG, LLP, 10 BANK STREET, SUITE 460, WHITE PLAINS, NY, 10606, US

(21) Appl. No.: 12/291,705

(22) Filed: Nov. 13, 2008

(30) Foreign Application Priority Data
Nov. 22, 2007 (DE) 10 2007 056 465.3

(51) Int. Cl. A47C 31/00; H05B 1/00

(52) U.S. Cl. 297/180.12; 219/217

(57) ABSTRACT

A motor vehicle seat with a seat heater comprises at least one heating element with metallic heating and/or contact conductors which are uninsulated or insulated with thin paint layers and which are applied to a carrier material. A textile layer with a liquid-repellent impregnation formed by an impregnating agent is arranged between the surface of the seat in contact with the user and the heating and/or contact conductors.

### BACKGROUND OF THE INVENTION

The present invention relates to a vehicle seat with a seat heater which comprises at least one heating element with metallic heating and/or contact conductors which are uninsulated or paint-insulated and mounted on a carrier material.

Vehicle seats as are presently installed in vehicles, particularly those that are used in middle and higher priced cars, are designed to be more and more comfortable. Nowadays, seat heaters are standard in such vehicle seats. Moreover, ventilating units are used for generating a comfortable climate in the area of the seat surface, especially during hot seasons.

It has been observed that in hot weather moisture forms in the area of the seat surface due to perspiration of the person sitting on the seat. This moisture is absorbed by the seat cover, if made of a fabric, and penetrates into the seat cushion. Likewise, during use of beverages and liquid foodstuffs, aggressive liquids might get spilled and then penetrate into the seat. This problem is also encountered in upholstery made of leather or fabric whenever the areas of the seat cushion and the seat backs are perforated or open-pored for the purpose of active or passive ventilation. In addition, the seat seams also show some permeability.

Especially the moisture released from the body is extremely aggressive and may damage a seat heater if it penetrates to the heating conductors and/or the contact conductors of the seat heater. It often happens that the moisture introduced into the seat contains ammonia, chlorides, phosphates and sulfur compounds. Ammonium compounds as well as hydrocarbons are nowadays widely used for textile finishing and cleaning purposes and is consequently contained in clothing in certain amounts, though very small ones. Due to this moisture, especially when ammonia is contained, the metallic parts of the heater can corrode, which may lead to failure of the seat heater. Due to the more and more complex structures of such seats a replacement of the seat heater is very troublesome and expensive.

Normally, a seat cushion, no matter whether it is used in the seat area or in the backrest, is constructed, when viewed from the seat area, of a surface cover (e.g. leather or fabric) and an intermediate layer of a nonwoven material or a fabric, which covers the heating and contact conductors held on a carrier material. A pad layer held by the structure of a seat frame is positioned underneath the carrier material carrying the heating and contact conductors.

### SUMMARY OF THE INVENTION

Starting from the above-described seats and the problems arising in connection therewith in the presence of moisture in the area of the seat surface in contact with the user, it is a principal object of the present invention to provide a vehicle seat with a seat heater whereby it is ensured that moisture formed in the area of the seat surface does not affect and damage the seat heater.

This object, as well as other objects which will become apparent from the discussion that follows, are achieved according to the present invention, in a vehicle seat with the above-mentioned features, by providing a textile layer with a liquid-repellent impregnation formed by an impregnating agent arranged between the seat surface in contact with the user and the heating and/or contact conductors.

As used herein, the term “contact conductors” is intended to mean and include electrical conductors which are in contact with the heating conductors and provide current to them.

The heating conductors are resistance heating elements which generate heat in the seat. By way of example and not limitation, such contact conductors and heating conductors are shown and described in the US Patent Publication No. 2008/0099458.

Such a textile layer with a liquid-repellent impregnation prevents liquids from deeply penetrating into the seat structure so as to avoid a situation where the seat heater itself gets damaged, also over long periods of time. Since use is made of a textile fiber layer comprising the impregnation, the properties, particularly the flexibility of the seat, are not impaired or substantially changed in comparison with conventional seats. Such an impregnation can be produced easily and at low costs on a textile layer and can be integrated without great efforts into the seat structure at the intended place underneath the surface in contact with the user of the seat. Moreover, such a textile layer will only negligibly increase the construction volume of the seat. As a rule, the seat comprises various layer structures for the seat padding so that one of said layers can be impregnated if such a layer exhibits corresponding properties.

Preferably, the impregnation is made from an impregnating agent that is applied to the fibers of the textile layer and covers the fibers and is in the form of a hydrophobic agent based on polymers of silicones. Hydrophobic agents based on polymers of fluorocarbons are particularly suited for impregnation. Polymers of fluorocarbons are distinguished by the feature that they adhere to the fibers very well, and the effect can thus be maintained for years.

While it is possible that this textile layer with impregnation still exhibits some breathability, but preferably is not liquid-permeable, it is also intended to block the pores and interspaces in the textile material with the hydrophobic agent.

The impregnated textile layer should preferably be resistant to water pressure for 5 mm water column to satisfy specific conditions of use in the vehicle.

To maintain the impregnation in a lasting way also under great loads, e.g. in trucks or in land and forest vehicles, the impregnating agent may also be bonded to the fibers by chemical reaction, which further enhances its efficiency over time, but also entails considerably higher equipment costs.

In the car sector the impregnation is preferably formed from a perfluoroalkylacryl copolymer, which can be applied in an immersion and subsequent drying process.

In one embodiment of the vehicle seat with seat heater, the heating conductors are formed from metal-coated plastic fibers extending in parallel in a strand, which have a very long mechanical lifetime.

Especially conductors which carry an inner core of conductive material which is protected by an outer layer of anticorrosive metal differing from the conductor material increasingly show corrosion under the action of moisture due to the different redox potentials.

For an easy and inexpensive construction the textile layer carrying the impregnation can be formed by the carrier material on which the heating and/or contact conductors are held.

To counteract conditions under which increased liquid amounts arise in the area of the surface layer of the seat, a liquid-storing buffer layer is arranged between the impregnated textile layer and the surface of the seat. Such a buffer layer should have the properties that it absorbs large amounts of excreted liquid, but discharges this liquid again by way of evaporation.

Such a buffer layer may be part of a padding layer.

To achieve the desired effect of the buffer layer, the buffer layer should preferably show wicking properties.

Such a buffer layer may be formed from a cellulose nonwoven fabric or from a polyester nonwoven fabric. In a further configuration, said buffer layer could also comprise portions of an area filled with a gelled hygroscopic agent, which then acts as a liquid reservoir.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a cross-sectional view schematically showing the configuration of a seat structure, e.g. of a seat area or a backrest.

FIG. 2 is a cross-sectional view showing a heating conductor made up of plastic fibers extending in parallel in a strand, which are metal-coated.

### DESCRIPTION OF THE PREFERRED EMBODIMENTS

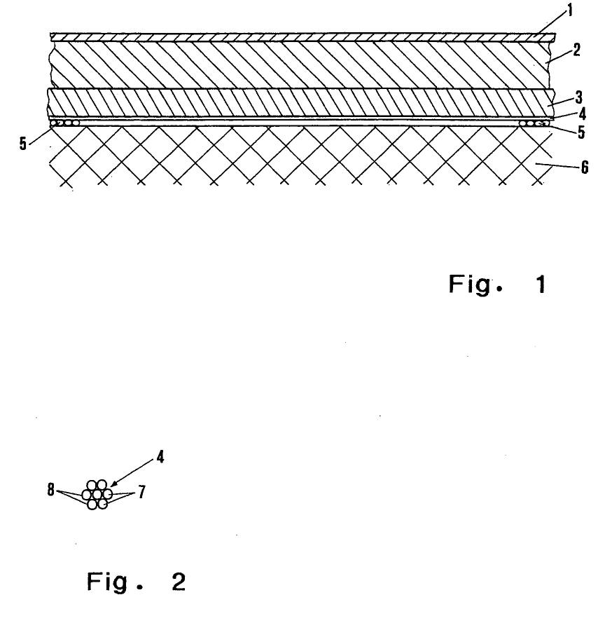

The preferred embodiments of the present invention will now be described with reference to FIGS. 1 and 2 of the drawings. Identical elements in the various figures are designated with the same reference numerals.

As can be seen in cross section in FIG. 1, the seat structure comprises a seat cover 1, which may be formed from a fabric, from leather imitate or from genuine leather. The upper side of this seat cover 1 forms the surface that is in contact with the person sitting on a seat, e.g. in the area of the seat surface or the backrest. A buffer layer 2 which is padded with a textile layer 3 is positioned underneath this seat cover 1 in the illustrated embodiment of the seat structure. Heating conductors 4 of the seat heater which extend between contact conductors 5 via which current is supplied to and discharged from the heating conductors 4 are arranged underneath this textile layer 3. The heating and contact conductors 4, 5 are in turn padded by a seat upholstery 6 (sketched), which is e.g. made of a rigid foam material.

The textile layer 3 is a fiber layer with an impregnation in the form of an impregnating agent which preferably shows hydrophobic properties and is applied to the fibers and covers the same. Such an impregnated textile layer 3 forms a barrier layer for liquid collecting in the area of the upper side of the seat cover 1, so that said liquid cannot pass to the heater with the heating and contact conductors 4, 5.

To buffer large amounts of liquid due to heavy moisture in the area of the seat surface, buffer layer 2 may be provided, said layer first storing the liquid penetrating into the seat structure to release it again in phases of non-use of the seat to the surface of the seat and thus to the ambient air. Such a buffer layer may be made of a fiber material or nonwoven material showing a certain wicking or capillary action for absorbing the liquid. Such a buffer layer may also comprise portions of an area filled with a gelled hygroscopic agent, so that the liquid is absorbed by the agent with penetration of moisture into the seat structure and a gel is formed. At any rate the seat heater is protected from moisture by the textile layer 3 provided with impregnation.

Especially heating conductors which consist of individual plastic fibers 7 extending in parallel in a strand, which are each provided on their exterior with a metallic coating 8, e.g., a layer of silver or nickel have very large surfaces as a result of the small diameter and the great number of filaments that may thus get heavily attacked by aggressive liquids.

The textile layer 3 can simultaneously form the carrier material to fasten the heating and contact conductors 4, 5 thereto. Such a layer 3, however, is made relatively thin, but it should in principle be pointed out that the thicknesses of the individual layers of the cushion structure of FIG. 1 are not shown true to scale, but can be chosen in response to the requirements.

There has thus been shown and described a novel vehicle seat with a seat heater which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A vehicle seat with a seat heater which comprises at least one heating element comprising at least one of metallic heating conductors and contact conductors which are uninsulated or insulated with thin paint layers and which are applied to a carrier material,
the improvement comprising
a textile layer with a liquid-repellent impregnation formed by an impregnating agent arranged between the surface of the seat in contact with a user and said conductors.

2. The vehicle seat according to claim 1, wherein the impregnation consists of an impregnating agent that is applied to the fibers of the textile layer and covers said fibers, and wherein the impregnating agent is in the form of a hydrophobic agent based on polymers of silicones.

3. The vehicle seat according to claim 1, wherein the impregnation consists of an impregnating agent that is applied to the fibers of the textile layer and covers said fibers, and wherein the impregnating agent is in the form of a hydrophobic agent based on polymers of fluorocarbons.

4. The vehicle seat according to claim 2, wherein the pores and interspaces in the textile material are also blocked with the hydrophobic agent.

5. The vehicle seat according to claim 1, wherein the impregnated textile layer is resistant to water pressure for 5 mm water column.

6. The vehicle seat according to claim 1, wherein the impregnating agent is bonded to the fibers due to chemical reaction.

7. The vehicle seat according to claim 1, wherein the impregnation is formed from a perfluoroalkylacryl copolymer.

8. The vehicle seat according to claim 1, wherein the heating conductors consist of metal-coated plastic fibers extending in parallel in a strand.

9. The vehicle seat according to claim 1, wherein the metal surface of the heating conductors carries a metallic coating which differs from the material of the respective heating conductor and envelops said heating conductor.

10. The vehicle seat according to claim 1, wherein the textile layer is formed by the carrier material on which the conductors are held.

11. The vehicle seat according to claim 1, further comprising a liquid-storing buffer layer which absorbs liquid and releases it again via evaporation is arranged between the impregnated textile layer and the surface of the seat.

12. The vehicle seat according to claim 11, wherein the buffer layer is part of a cushioning layer.

13. The vehicle seat according to claim 11, wherein the buffer layer exhibits wicking properties.

14. The vehicle seat according to claim 11, wherein the buffer layer is formed from a cellulose nonwoven.

15. The vehicle seat according to claim 11, wherein the buffer layer comprises portions of an area filled with a gelled hygroscopic agent, the portions acting as liquid reservoirs.
